(19) United States
(12) Patent Application Publication
(10) Pub. No.: US 2021/0224833 A1
(43) Pub. Date: Jul. 22, 2021

(54) Seasonality Prediction Model

(71) Applicant: Oracle International Corporation, Redwood Shores, CA (US)

(72) Inventors: Ming LEI, Ellicott City, MD (US); Catalin POPESCU, Atlanta, GA (US)

(21) Appl. No.: 16/868,692

(22) Filed: May 7, 2020

Related U.S. Application Data
(60) Provisional application No. 62/963,773, filed on Jan. 21, 2020.

(51) Int. Cl. G06Q 30/02; G06Q 50/28; G06Q 20/20; G06N 5/04; G06N 20/00

(52) U.S. Cl. CPC G06Q 30/0202; G06Q 50/28; G06N 20/00; G06N 5/04; G06Q 20/202

(57) ABSTRACT

Embodiments predict/forecast demand of a product by receiving historical sales data for the product and, using a plurality of different seasonality estimation methods, estimating a plurality of different seasonality estimations for future time periods and determining an approximate error amount for each of the different seasonality estimations. Embodiments determine a weight for each of the plurality of different seasonality estimation methods based on the corresponding approximate error amount and generate an aggregate seasonality model based on the plurality of different seasonality estimations and the weights. Embodiments then determine a demand forecast using the aggregate seasonality model.

### CROSS REFERENCE TO RELATED APPLICATIONS

This application claims priority to U.S. Provisional Patent Application Ser. No. 62/963,773, filed Jan. 21, 2020, the disclosure of which is hereby incorporated by reference.

### FIELD

One embodiment is directed generally to a prediction model, and in particular to a prediction model to predict seasonality used for demand forecasting.

### BACKGROUND INFORMATION

Machine learning algorithms build a mathematical model based on sample data, known as “training data”, in order to make predictions or decisions without being explicitly programmed to perform the task. Meanwhile, data mining focuses on the discovery of previously unknown properties in the data. Both machine learning and data mining can be used to analyze a large amount of data, and use the analysis to make future predictions.

Predictions using machine learning and data mining are needed in the retail industry, where retailers need to predict their demand in the future to better manage their inventory or promotion/markdown planning. Retailers may engage in many types of promotions to boost their sales. To generate an accurate forecast, a retailer has to consider all factors/features which could impact the demand, such as promotions, price, seasonality, weather, etc.

In general, sales forecast systems encounter problems in producing a week-by-week forecast of sales units for retail items. The sales of retail items in a given week is affected by many factors, such as seasonal factors, whether a discount has been applied to a retail item during the week, and at what point in the lifecycle of a merchandise the week falls. One common approach to forecasting weekly sales units involves building a “causal demand model” for retail items. This demand model is a mathematical model that describes weekly sales units in terms of factors such as the ones listed above. The factors are known as the “demand variables” or “demand features” that form a demand model.

The demand model specifies mathematically how the demand variables affect sales units. For example, if the amount of discount is a demand variable, historical data may show that a 50% price cut resulted in a 4-fold increase in sales units (i.e., related to price elasticity). In this example, the demand variable is a 50% price cut and the historical sales data is the 4-fold increase in sales. In order for the causal demand model to be of use in forecasting sales units, it is necessary to determine the relationship of the demand variable (50% price cut) to the sales units (4-fold increase). This relationship is referred to as the “demand parameter” associated with the demand variable.

In this example, the demand parameter may be determined to specify that for every 25% price reduction, sales of a particular retail item will increase by 2-fold. With the demand parameter determined, it is then possible to forecast sales units by specifying the future values of the demand variables. To continue the price cut example, the retailer might know that next season it will be running a 40% price cut during some weeks. The demand model will then forecast sales units for those weeks accounting for the 40% price cut.

The demand parameter is determined by examining historical retail sales data (known as “retail panel data”) containing price cuts for the retail item itself, or for similar retail items. However, as noted above, several demand variables affect the sales of retail items. These several demand variables apply simultaneously. For example, a retailer may have performed the 50% price cut during the summer for a summer item, in which case the 4-fold increase in sales may be partially due to an increase in seasonal demand for summer retail items during summer. To separate the effects of the several demand variables on sales, a regression is performed on the demand model to determine values for demand parameters that cause the demand model to best fit retail panel data.

Further, the quality of a sales forecast is very dependent on the quality of the input data (i.e., garbage in, garbage out). In many situations, the historical data necessary and available for sales forecasting is less than adequate, and the resulting forecasts can do more harm than good. Some known sophisticated forecasting solutions offer an exception driven workflow, where such bad forecasts are detected and a forecast analyst is prompted to review and adjust the forecast manually. Less sophisticated solutions do not catch the bad numbers, which can result in over/understock, wrong allocations, bad plans, etc.

### SUMMARY

Embodiments predict/forecast demand of a product by receiving historical sales data for the product and, using a plurality of different seasonality estimation methods, estimating a plurality of different seasonality estimations for future time periods and determining an approximate error amount for each of the different seasonality estimations. Embodiments determine a weight for each of the plurality of different seasonality estimation methods based on the corresponding approximate error amount and generate an aggregate seasonality model based on the plurality of different seasonality estimations and the weights. Embodiments then determine a demand forecast using the aggregate seasonality model.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a computer system having a computing device configured with an auto clustering prediction models tool in accordance to embodiments.

FIG. 2 is a block diagram of computer server/system in accordance with an embodiment of the present invention.

FIG. 3 is a flow diagram of the functionality of seasonality prediction model tool of FIG. 1 when estimating seasonality effects that can be used for a demand forecast in accordance with one embodiment.

FIGS. 4A-B and 5 illustrate an example of an implementation of embodiments of the invention, and how each example corresponds to the functionality of FIG. 3.

FIG. 6 illustrates an integrated manufacturing, inventory and logistics system that includes demand forecasting as disclosed herein in accordance with one embodiment.

### DETAILED DESCRIPTION

Embodiments generate a seasonality prediction model using multiple different seasonality curves/profiles as input. Embodiments, in aggregating multiple different seasonality profiles, uses weights that are calculated based on an estimation error. The seasonality prediction model is then used to predict demand for retail products/items.

As discussed above, in the retail industry, retailers need to predict future demand to better manage their inventory or promotion/markdown planning. To accurately forecast demand, retailers consider all factors that could impact the demand such as promotions, price change, seasonality, weather and so on. Known solutions for retailers have used various algorithms to estimate the promotion or price effects.

The term “item” or “retail item”, as used herein, refers to merchandise sold, purchased, and/or returned in a sales environment. The terms “particular item” and “single item” are used interchangeably herein and refer to a particular item type (e.g., to a particular type of cellular telephone such as an iPhone 8), not to a unit item.

The terms “period”, “time period”, “retail period”, or “calendar period”, as used herein, refer to a unit increment of time (e.g., a 7-day week) which sellers use to correlate seasonal periods from one year to the next in a calendar for the purposes of planning and forecasting. The terms may be used interchangeably herein.

The term “sales channel” or “location” or “retail location”, as used herein, may refer to a physical store where an item is sold, or to an online store via which an item is sold.

The term “sales data”, as used herein, refers to historical sales and promotion information that has been recorded for an item that has been sold in past retail periods (e.g., over 52 weeks of the past year). Sales data may include, for example, a number of units (or a monetary amount) of an item sold in each retail period, along with data characterizing one or more types of promotions for the item. Sales data may be stored in a database, for example.

The terms “promotion” and “sales promotion” are used interchangeably herein and refer to a particular type of promotion for an item. Some examples of promotion components may include a price discount promotion component, a television advertisement component, a radio advertisement component, a newspaper advertisement component, an internet advertisement component, an email advertisement component, and an in-store advertisement component.

The term “promotion effect” refer to a numerical value that characterizes the effect (e.g., the effect on sales and profitability) of promoting an item. For example, an estimated promotion effect of 2.0 may indicate that a promotion, or combination or promotions, is estimated to result in twice as many sales (a 100% increase) for an item. Promotion effects (i.e., values) may be used in a demand forecast model to forecast a demand for an item. Promotion effects may also be used in a computerized inventory system to control various aspects of inventory for an item.

Embodiments, in general, utilize the following demand model or function for demand forecasting (“equation (1)”):

Demand=base demand*seasonality*promo effects(*additional features effects) (1)

Where “base demand” is the historical demand without taking account any effects or other factors, seasonality is the impact on demand based on the season (i.e., time of year), and promo effects are the effects on demand based on one or more promotions offered during a time period. Any or all additional features/variables that impact demand can be added to the model as appropriate. However, the number of features could exceed 100 in some situations.

Many demand models take into account additional effects, such as the weather. For example, if the current year's weather differs significantly from the previous year, and from two years ago, the forecast may need corrections. For example, if the hot weather during Summer is longer this year, the forecast for steaks and ice cream may need to be increased. Another additional effect can be the inventory. If a popular fashion is out of some sizes and/or colors, the forecast may need to be adjusted downward to account for the missing articles. Yet another effect can be store count. If the retailer plans to aggressively expand, and increase the number of stores by 10% in the following year, the forecast needs to be adjusted accordingly. However, for purposes of embodiments of the invention, it is assumed that seasonality and promotion effects have the overwhelmingly largest impact on the sales forecast.

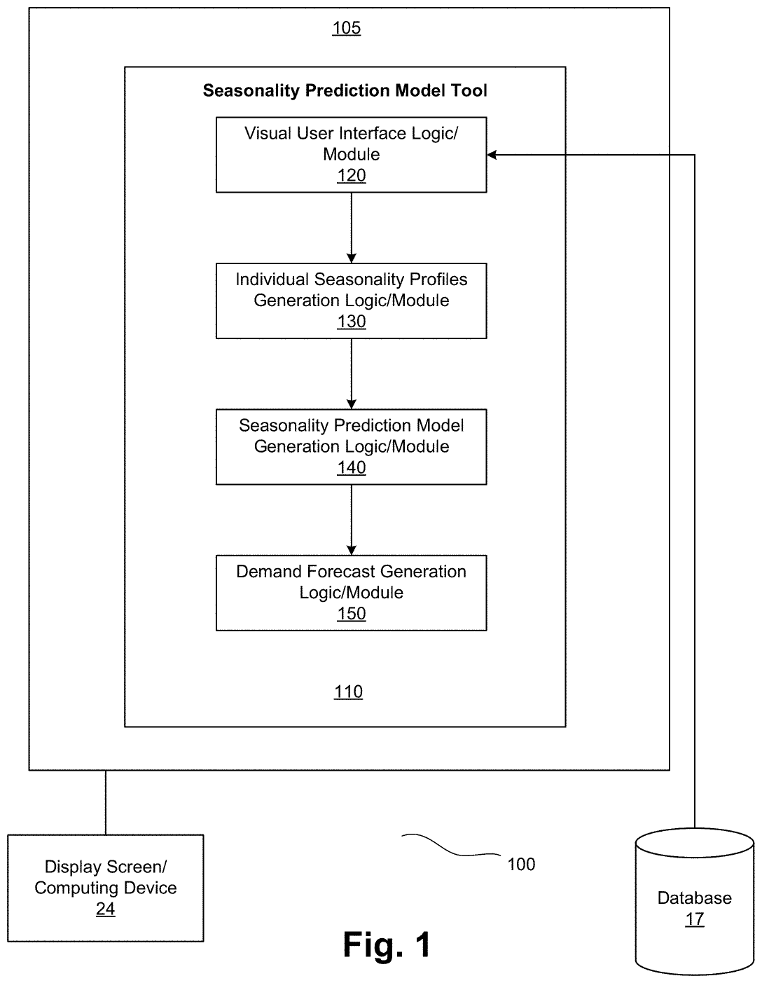

FIG. 1 illustrates a computer system 100 having a computing device 105 configured with seasonality prediction model tool 110 in accordance to embodiments. In one embodiment, seasonality prediction model tool 110 may be part of a larger computer application (e.g., a computerized inventory management and demand forecasting application), configured to forecast and manage sales, promotions, and inventory for retail items at various retail locations. Seasonality prediction model tool 110 is configured to computerize the process of analyzing sales data to generate a seasonality model that may be used by a demand equation/model to forecast demand for items.

In one embodiment, system 100 is a computing/data processing system including an application or collection of distributed applications for enterprise organizations. The applications and computing system 100 may be configured to operate with or be implemented as a cloud-based networking system, a software-as-a-service (“SaaS”) architecture, or other type of computing solution.

In one embodiment, a computer algorithm is disclosed that implements an analytical approach to determining the impact of seasonality on demand for an item, or a class of items, at a store, or at multiple stores. It is assumed herein that sales data is available for use and that a demand model is defined which can be used with the generated a seasonality prediction model from the sales data.

The forecast is an important driver of the supply chain. If a forecast is inaccurate, allocation and replenishment perform poorly, resulting in financial loss for the retailer. Improvements in forecast accuracy for promoted items may be achieved by the embodiments disclosed herein. Further, a better understanding of the impact a promotion has on demand may be achieved. This helps the retailer to more effectively plan promotions with respect to channel, pricing, and customer segments, for example.

In one embodiment, seasonality prediction model tool 110 is implemented on computing device 105 and includes logics or modules for implementing various functional aspects of seasonality prediction model tool 110. In one embodiment, seasonality prediction model tool 110 includes visual user interface logic/module 120, individual seasonality profiles generation logic/module 130, seasonality prediction model generation logic/module 140, and demand forecast generation logic/module 150.

Other embodiments may provide different logics or combinations of logics that provide the same or similar functionality as seasonality prediction model tool 110 of FIG. 1. In one embodiment, seasonality prediction model tool 110 is an executable application including algorithms and/or program modules configured to perform the functions of the logics. The application is stored in a non-transitory computer storage medium. In one embodiment, the logics of seasonality prediction model tool 110 are implemented as modules of instructions stored on a computer-readable medium.

Computer system 100 also includes a display screen 24 operably connected to computing device 105. In accordance with one embodiment, display screen 24 is implemented to display views of and facilitate user interaction with a graphical user interface (“GUI”) generated by visual user interface logic 120 for viewing and updating information associated with generating the seasonality prediction model (e.g., seasonality curves, sales data, etc.). The graphical user interface may be associated with a demand forecast application and visual user interface logic 120 may be configured to generate the graphical user interface.

In one embodiment, computer system 100 is a centralized server-side application that provides at least the functions disclosed herein and that is accessed by many users via computing devices/terminals communicating with the computer system 100 (functioning as the server) over a computer network. Therefore, display screen 24 may represent multiple computing devices/terminals that allow users to access and receive services from seasonality prediction model tool 110 via networked computer communications.

In one embodiment, computer system 100 further includes at least one database 17 operably connected to computing device 105 and/or a network interface to access database 17 via a network connection. For example, in one embodiment, database 17 is operably connected to visual user interface logic 120. In accordance with one embodiment, database 17 is configured to store and manage data structures (e.g., records of sales data) associated with seasonality prediction model tool 110 in a database system (e.g., a computerized inventory management and demand forecasting application).

In one embodiment, visual user interface logic 120 is configured to generate a graphical user interface (“GUI”) to facilitate user interaction with seasonality prediction model tool 110. For example, visual user interface logic 120 includes program code that generates and causes the graphical user interface to be displayed based on an implemented graphical design of the interface. In response to user actions and selections via the GUI, associated aspects of generating seasonality curves and prediction models for retail items may be manipulated.

For example, in one embodiment, visual user interface logic 120 is configured to facilitate receiving inputs and reading data in response to user actions. For example, visual user interface logic 120 may facilitate selection, reading, and inputting of sales data (seasonality information and unit sales data or monetary sales data) associated with retail items sold at retail locations. The sales data may reside in at least one data structure (e.g., within database 17) associated with (and accessible by) a seasonality curve generation and model training application (e.g., seasonality prediction model tool 110) via the graphical user interface.

Sales data may include, for example, data representing past sales and promotions of an item across a plurality of past retail periods. The sales data may be segmented into retail periods of past weeks, with each past week having numerical values assigned to it to indicate the number of items sold (or monetary amount acquired for items) for that week. The sales data may also include numerical values representing price discounts and values of other promotion components across the retail periods, and seasonality information (which may also be separate from the sales data) in accordance with one embodiment. The sales data for an item may be accessed via network communications, in accordance with one embodiment.

In one embodiment, individual seasonality profiles generation logic/module 130 is configured to generate individual seasonality profiles/curves using different methodologies, as disclosed below.

In one embodiment, seasonality prediction model generation logic/module 140 is configured to train an aggregate seasonality prediction model using as input the seasonality profiles generated by logic 130. As additional sales data is generated, the seasonality model is continuously trained and generated to make the model more accurate. In one embodiment, demand forecast generation logic/module 150 generates a forecast of demand using the seasonality prediction model generated from 140.

In one embodiment, the generated prediction of demand predicts an amount of needed inventory (e.g., for an item at a single store) which is then used for orders to a computerized inventory system (e.g., by a computerized inventory management and demand forecasting system). The prediction of demand may also control an amount of inventory (e.g., for an item at a single store) to be allocated by the computerized inventory system. The prediction of demand may further control adjustment of an amount inventory (e.g., for an item at a single store) by the computerized inventory system.

In this manner, seasonality prediction model tool 110 is configured to generate a seasonality model that better represents actual effects of seasonality of the retail item and can be used to predict demand.

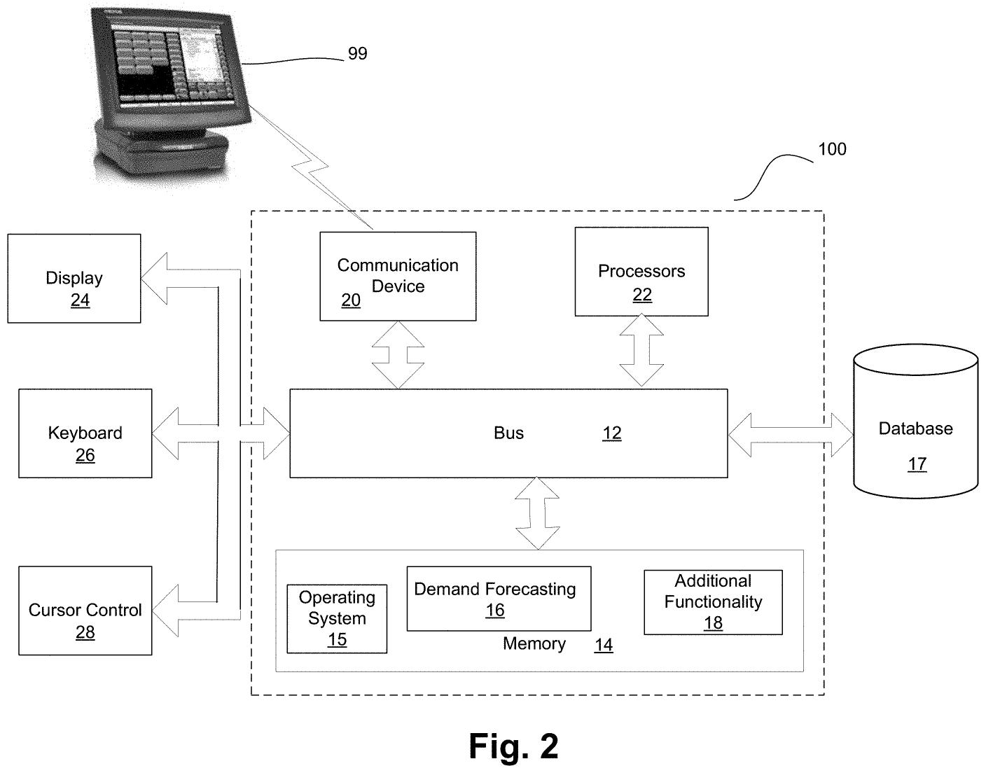

FIG. 2 is a block diagram of computer server/system 100 in accordance with an embodiment of the present invention. FIG. 2 illustrates further hardware/software details of system 100. Although shown as a single system, the functionality of system 10 can be implemented as a distributed system. Further, the functionality disclosed herein can be implemented on separate servers or devices that may be coupled together over a network. Further, one or more components of system 100 may not be included. For example, for functionality of a server, system 100 may need to include a processor and memory, but may not include one or more of the other components shown in FIG. 2, such as a keyboard or display.

System 100 includes a bus 12 or other communication mechanism for communicating information, and a processor 22 coupled to bus 12 for processing information. Processor 22 may be any type of general or specific purpose processor. System 100 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 100 further includes a communication device 20, such as a network interface card, to provide access to a network. Therefore, a user may interface with system 100 directly, or remotely through a network, or any other method. Some or all of the components of system 100 can implement the entirety

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to display 24, such as a Liquid Crystal Display (“LCD”). A keyboard 26 and a cursor control device 28, such as a computer mouse, are further coupled to bus 12 to enable a user to interface with system 100.

In one embodiment, memory 14 stores software modules that provide functionality when executed by processor 22. The modules include an operating system 15 that provides operating system functionality for system 100. The modules further include a demand forecasting module 16 that implements one or more of modules 120, 130, 140, 150, and all other functionality disclosed herein. System 100 can be part of a larger system. Therefore, system 100 can include one or more additional functional modules 18 to include the additional functionality, such as a retail management system (e.g., the “Oracle Retail Demand Forecasting System” or the “Oracle Retail Advanced Science Engine” (“ORASE”) from Oracle Corp.) or an enterprise resource planning (“ERP”) or other type of inventory management system. Database 17 is coupled to bus 12 to provide centralized storage for modules 16 and 18 and store customer data, product data, transactional data, etc. In one embodiment, database 17 is a relational database management system (“RDBMS”) that can use Structured Query Language (“SQL”) to manage the stored data. In one embodiment, a specialized point of sale (“POS”) terminal 99 generates the transactional data and historical sales data (e.g., data concerning transactions of each item/SKU (stock-keeping unit) at each retail store) used to forecast demand. POS terminal 99 itself can include additional processing functionality to forecast demand in accordance with one embodiment and can operate as a specialized demand forecasting system either by itself or in conjunction with other components of FIG. 2.

In one embodiment, particularly when there are a large number of retail stores, a large number of items, and a large amount of historical data, database 17 is implemented as an in-memory database (“IMDB”). An IMDB is a database management system that primarily relies on main memory for computer data storage. It is contrasted with database management systems that employ a disk storage mechanism. Main memory databases are faster than disk-optimized databases because disk access is slower than memory access, the internal optimization algorithms are simpler and execute fewer CPU instructions. Accessing data in memory eliminates seek time when querying the data, which provides faster and more predictable performance than disk.

In one embodiment, database 17, when implemented as a IMDB, is implemented based on a distributed data grid. A distributed data grid is a system in which a collection of computer servers work together in one or more clusters to manage information and related operations, such as computations, within a distributed or clustered environment. A distributed data grid can be used to manage application objects and data that are shared across the servers. A distributed data grid provides low response time, high throughput, predictable scalability, continuous availability, and information reliability. In particular examples, distributed data grids, such as, e.g., the “Oracle Coherence” data grid from Oracle Corp., store information in-memory to achieve higher performance, and employ redundancy in keeping copies of that information synchronized across multiple servers, thus ensuring resiliency of the system and continued availability of the data in the event of failure of a server.

In one embodiment, system 100 is a computing/data processing system including an application or collection of distributed applications for enterprise organizations, and may also implement logistics, manufacturing, and inventory management functionality. The applications and computing system 100 may be configured to operate with or be implemented as a cloud-based networking system, a software-as-a-service (“SaaS”) architecture, or other type of computing solution.

Embodiments are disclosed from the perspective that, for an item (i.e., a class of items such as yogurt or men's shirts or an individual SKU) sold at a location (e.g., a retail location), the item may be promoted in various ways at various times (i.e., pre-defined retail periods, such as a day, week, month, year, etc.). A retail calendar has many retail periods (e.g., weeks) that are organized in a particular manner (e.g., four (4) thirteen (13) week quarters) over a typical calendar year. A retail period may occur in the past or in the future. Historical sales/performance data may include, for example, a number of units of an item sold in each of a plurality of past retail periods as well as associated promotion data (i.e., for each retail period, which promotions were in effect for that period) and any other relevant demand features/variables.

Embodiments provide a prediction model to estimate seasonality on demand by aggregating seasonality profiles from different estimation methods with weights which are calculated based on an estimation error of each method. The generated prediction model provides a more accurate estimation of seasonality impacts than each of the separate seasonality profiles, and the model can be updated (i.e., can learn) as more historical sales data is received.

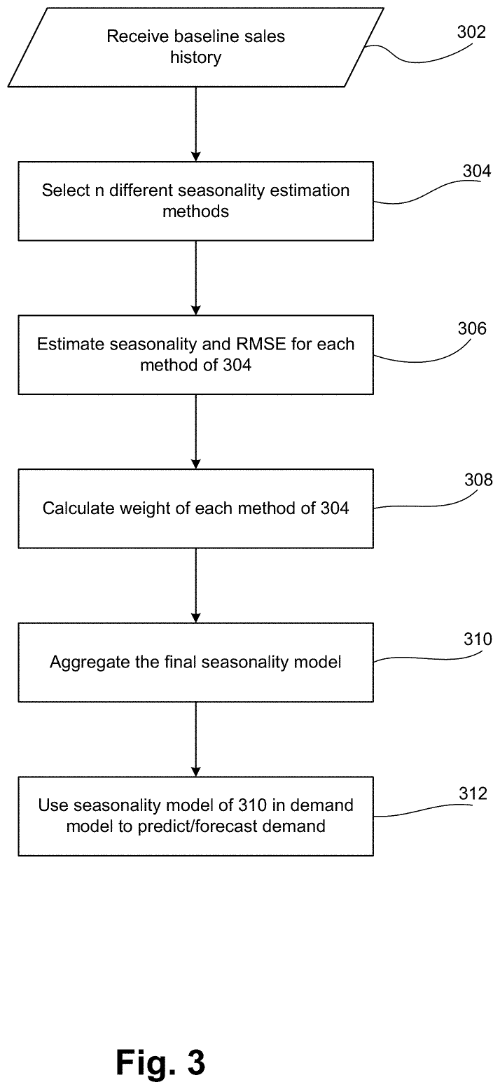

FIG. 3 is a flow diagram of the functionality of seasonality prediction model tool 110 of FIG. 1 when estimating seasonality effects that can be used for a demand forecast in accordance with one embodiment. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 302, historical item sales data is received for all items for all stores for a particular class/category of products, or for only a single item of interest. For example, the class/category can be “yogurt”, “coffee” or “milk.” Each class has one or more subclasses, all the way down to the SKU or Universal Product Code (“UPC”) level, which would be each individual item for sale. For example, for the class of yogurt, a sub-class could be each brand of yogurt, and further sub-classes could be flavor, size, type (e.g., Greek or regular), down to an SKU which would correspond to every individual different type of yogurt item sold. Embodiments can use various aggregation levels which the user can select in a user interface, including subclass/store, class/store, SKU/region, subclass/region, etc.

Historical sales and performance data may include, for example, data representing past sales and promotions of each item across a plurality of past retail sales periods. The historical performance data may be segmented into retail periods of past weeks, with each past week having numerical values assigned to it to indicate the number of items sold for that week. The historical performance data may also include numerical values representing price discounts and values of other promotion components across the retail periods, in accordance with one embodiment. The historical performance data for an item may be accessed via network communications, in accordance with one embodiment, including being accessed from each POS terminal 99 at each retail store and/or accessed from database 17.

The historical performance data includes sales data associated with the plurality of promotion components across a plurality of time periods (e.g., weeks). Examples of promotion components include, but are not limited to, a price discount component, a television advertisement component, a radio advertisement component, a newspaper advertisement component, an email advertisement component, an internet advertisement component, and an in-store advertisement component. The historical data includes, for each item, a listing of feature/variables/attributes for the item, such as price, promotions, seasonality, brand, color, style, etc.

The historical sales data is received as weekly baseline sales data (or any other time period). In embodiments, the sales data can be received by electronically parsing data generated by all POSs 99 at all relevant retail stores. In embodiments, two years of baseline sales history is received at 302. Baseline sales includes seasonality, but price and promotion information is removed. In embodiments, seasonality is captured at the week of year level so for every product location combination there are 52 or 53 seasonality indices.

At 304, “n” different seasonality estimation methods are selected, where n is 3 or more in one embodiment. The possible methods can be any known methods of estimating seasonality. In embodiments, the n methods include (1) Time series analysis using “regular” Holt-Winter's additive method and Holt-Winter's multiplicative method; (2) “revised” Oracle Holt-Winter's additive and multiplicative methods; (3) sinusoidal model; and (4) Regression with Fourier terms.

At 306, for each of the selected n seasonality estimation methods, the seasonality is estimated and the corresponding RMSE for the estimation is determined.

Specifically, the Holt-Winters, or “regular” forecasting algorithm takes into account both trends and seasonality in the time series data in order to formulate a prediction about future values. A trend in this context refers to the tendency of the time series data to increase or decrease over time, and seasonality refers to the tendency of time series data to exhibit behavior that periodically repeats itself. A season generally refers to the period of time before an exhibited behavior begins to repeat itself. The additive seasonal model is given by the following formulas:

Lₜ=α(Xₜ−Sₜ₋ₚ)+(1−α)(Lₜ₋₁+Tₜ₋₁)

Tₜ=γ(Lₜ−Lₜ₋₁)+(1−γ)Tₜ₋₁

Sₜ=δ(Xₜ−Lₜ)+(1−δ)Sₜ₋ₚ

where Xₜ, Lₜ, Tₜ, and Sₜ denote the observed level, local mean level, trend, and seasonal index at time t, respectively. Parameters α, γ, δ denote smoothing parameters for updating the mean level, trend, and seasonal index, respectively, and p denotes the duration of the seasonal pattern. The forecast is given as follows:

Fₜ₊ₖ=Lₜ+kTₜ+Sₜ₊ₖ₋ₚ

where Fₜ₊ₖ denotes the forecast at future time t+k.

The “regular” additive seasonal model is typically applied when seasonal fluctuations are independent of the overall level of the time series data. An alternative, referred to as the multiplicative model, is often applied if the size of seasonal fluctuations vary based on the overall level of the time series data. The “regular” multiplicative model is given by the following formulas:

Lₜ=α(Xₜ/Sₜ₋ₚ)+(1−α)(Lₜ₋₁+Tₜ₋₁)

Tₜ=γ(Lₜ−Lₜ₋₁)+(1−γ)Tₜ₋₁

Sₜ=δ(Xₜ/Lₜ)+(1−δ)Sₜ₋ₚ

where, as before, Xₜ, Lₜ, Tₜ, and Sₜ denote the observed level, local mean level, trend, and seasonal index at time t, respectively. The forecast is then given by the following formula:

Fₜ₊ₖ=(Lₜ+kTₜ)Sₜ₊ₖ₋ₚ

In general, the forecast for all Holt-Winters implementation is a combination of the level, trend and seasonality, as well as the trend dampening factor, φ. While the formulas are the same for the Regular and Oracle/Revised Winters implementations, the difference lies in the way the level, trend and seasonality indices are calculated/optimized. During the estimation of the seasonality curves, embodiments optimize all exponential smoothing parameters α, γ, δ.

For Regular Winters, the parameters are optimized, by trying to find the level, trend, seasonality combination that best fits the historical data. The flow is as follows:
Start with initial values of the exponential smoothing parameters
Calculate the level, trend, and seasonality
Compare resulting forecast with the historical data; record how well I did
Using a steepest gradient approach, compute another set of smoothing parameters
Calculate new level, trend, and seasonality
Compare resulting forecast with historical data; record how well I did
. . . repeat until I find the parameters that yield the combination of level trend and seasonality that best fits historical data.

For Oracle/Revised Winters, the optimization is very similar, but seasonality is kept constant. The smoothing parameters are optimized such that only level and trend are modified. In cases with very stable seasonal pattern, optimizing with respect to seasonality is not contributing to a better fit of the historical demand.

The sinusoidal model is used to approximate a sequence Yᵢ as follows:

Yᵢ=C+α sin(ωTᵢ+ϕ)+Eᵢ

where C is constant defining a mean level, α is an amplitude for the sine wave, ω is the frequency, Tᵢ is a time variable, φ is the phase, and Eᵢ is the error sequence in approximating the sequence Yᵢ by the model. This sinusoidal model can be fit using nonlinear least squares; to obtain a good fit, nonlinear least squares routines may require good starting values for the constant, the amplitude, and the frequency.

The regression with Fourier terms method, similar to using the sinusoidal model, adds Fourier terms into regression models to utilize sine and cosine terms in order to simulate seasonality. However, the seasonality of such a regression would be represented as the sum of sine or cosine terms, instead of a single sine or cosine term in a sinusoidal model. Every periodic function can be approximated with the inclusion of Fourier terms as follows:

$${Y}_{i} = α + bt + ( {\sum }_{k = 1}^{K} {α}_{k} \cdot sin ( \frac{2 kt}{m} ) + {β}_{k} \cdot cos ( \frac{2 kt}{n} ) ) + {E}_{i} .$$

Known Root Mean Square Error (“RMSE”) methods can be used to determine the RMSE of each estimated seasonality at 304. In one embodiment, RMSE is determined as follows, and is determined for each training period (e.g., a 13 week training period):

RMSE=\sqrt{(̅f̅−̅o̅)̅²̅}

where f is the forecasts (expected values or unknown results) and o is the observed values (known results or actual sales). In other embodiments, other error metrics can be used, such as mean absolute percentage error (“MAPE”), which is some instances is preferable because it measures the error in terms of percentage.

At 308, for each seasonality method determined at 306, a corresponding weight is determined. The weights are determined as follows, for each seasonality method “i” for each of n methods (“equation (2)”):

$${W}_{i} = \frac{1 / RMSE ( i )}{{Σ}_{i = 1}^{n} 1 / RMSE ( i )} \qquad ( 2 )$$

At 310, the seasonality “model” is trained/created by aggregating/combining each of the seasonality method results using the weights determined at 308 as follows (“equation (3)”):

Sₜ=Σᵢ₌₁ⁿWᵢsᵢ^{t} (3)

where Sₜ is the estimated seasonality at period (t), sᵢ^{t} is the estimated seasonality by method (i) at period (t) and Wᵢ is the weight of the method (i). Note how i goes from 1 to n (i.e., the number of estimation methods considered). The time period t denotes the seasonal index for a week and goes from 1 to 52 (for most years), or 1 to 53 (every 7 years or so). In embodiments, every week the new sales information is fed into the estimation module and the models are retrained to keep updating the seasonality. Better seasonality leads to more accurate forecasts.

At 312, the seasonality estimate from 310 is used to predict a final demand, using promotional effects that are determined using any known methods. In one embodiment, the following demand forecast algorithm is used to predict demand:

Demand=base demand*seasonality*promo effects

This is a relatively simple demand algorithm and much more complex demand forecast algorithms can be used in other embodiments as long as they incorporate the seasonality in the demand forecast in any way.

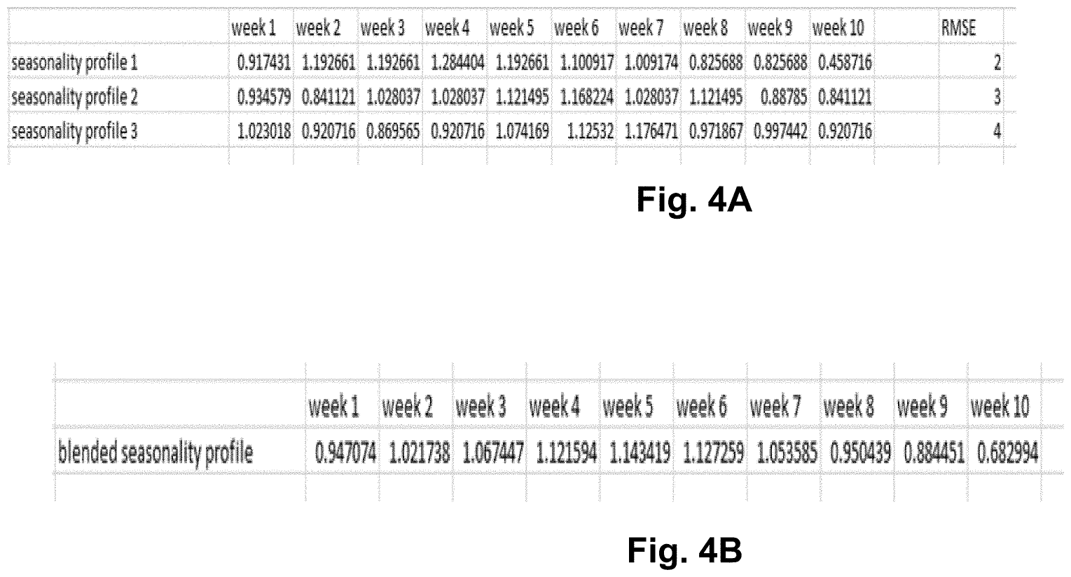

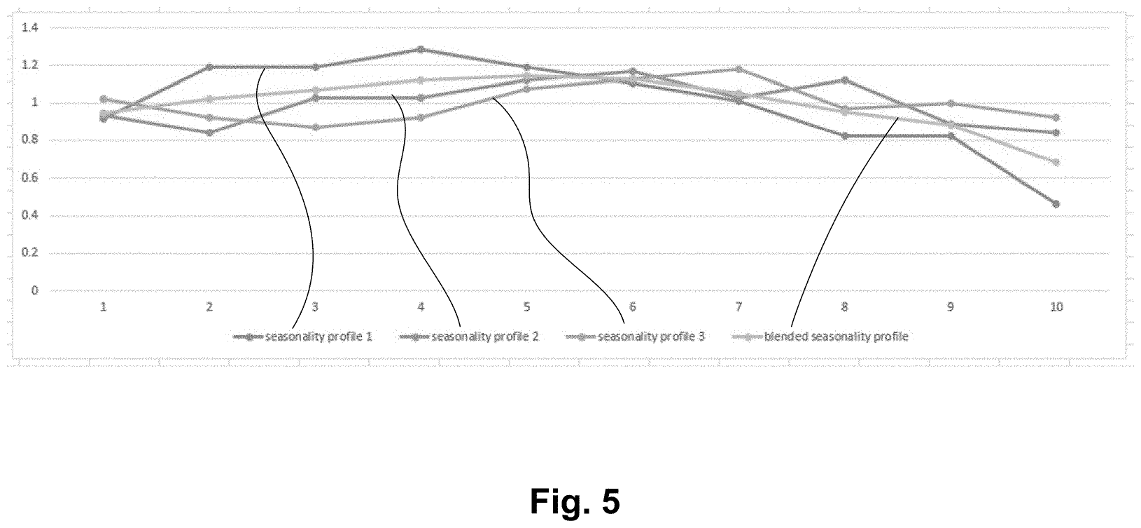

FIGS. 4A-B and 5 illustrate an example of an implementation of embodiments of the invention, and how each example corresponds to the functionality of FIG. 3. In this relatively simplified example, it is assumed that the retailers use the following formula to model demand:

demand=base demand*seasonality

and, for simplicity, it is assumed that the base demand is 5 for all product/store combinations.

FIG. 4A illustrates the results of 306 where 3 seasonality methods are used and seasonality is determined for each of 10 future weeks based on two years of baseline sales history received at 302. What is shown in FIG. 4A can be considered simplified seasonality curves.

At 308, the weight of each of the results shown at FIG. 4A are determined using equation 2 above. The results are as follows:

Weight for seasonality profile 1: 0.461538

Weight for seasonality profile 2: 0.307692

Weight for seasonality profile 3: 0.230769

At 310, equation 3 above is used to train the final aggregate seasonality model using the above weights. FIG. 4B shows the results of 310. At 312, the value of each week for seasonality is used in the demand formula to predict demand for that week.

FIG. 5 graphically the three seasonality profiles together with the “blended” profile generated by the seasonality model.

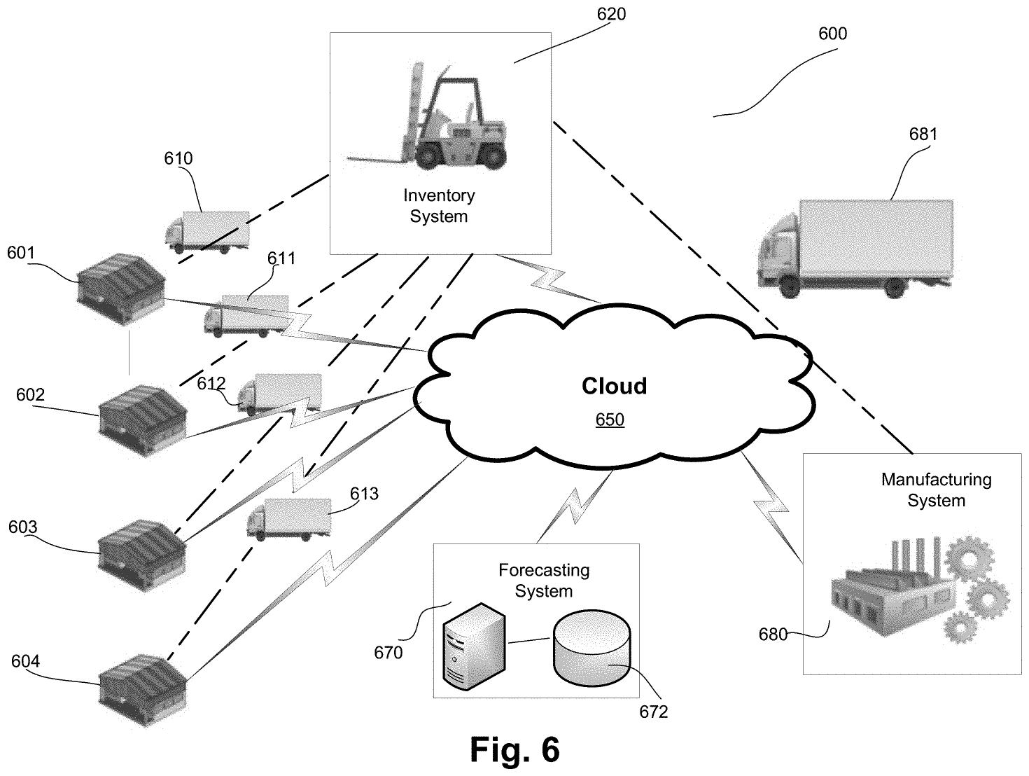

FIG. 6 illustrates an integrated manufacturing, inventory and logistics system 600 that includes demand forecasting as disclosed herein in accordance with one embodiment. As shown in FIG. 6, system 600 can include a product demand forecasting system 670 that forecasts future product demand and in some instances forecasts and/or considers future demand for hundreds of thousands of products, or in some applications tens of millions or more products at one or more retail stores 601-604. Forecasting system 670 is in communication through a cloud network 650 or other type of communications network with one or more inventory systems 620 and one or more manufacturing systems 680.

Forecasting system 670 generates demand forecasting by implementing the functionality disclosed in conjunction with FIG. 3 above. Inventory system 620 stores inventory and provides transportation logistics to deliver items to stores 601-604 using trucks 610-613 or some other transportation mechanisms. Inventory system 620 in one embodiment implements an Enterprise Resource Planning (“ERP”) specialized computer system or a specialized inventory control system that uses input from demand forecasting system 670 to determine levels of inventories and the amount and timing of the delivery of items to stores 601-604. The functionality of FIG. 6 can be completely automated in some embodiments using automated loading mechanisms and self-driving transportation.

Manufacturing system 680 manufactures items to be sent to inventory system 620 and provides transportation logistics to deliver the items to inventory system 620 using a truck 681 or some other transportation mechanisms. Manufacturing system 680 in one embodiment implements an ERP specialized computer system or a specialized manufacturing system that uses input from forecasting system 670 to determine an amount of items to manufacture, inventory of resources that are used for the manufacturing, and the amount and timing of the delivery of items to inventory system 620.

Forecasting system 670 can utilize information from inventory system 620, a sales tracking system (not shown) and/or databases in forecasting demand for products. In forecasting demand, forecasting system 670 attempts to predict uncharacteristic demand of one or more products that results from events, weather, social demand, economic factors and other factors. Tens, to hundreds to thousands of different variables may be tracked that can have an effect on the demand of one or more products. Changes in these variables can result in uncharacteristic demands. For example, changes in forecasted weather can be tracked, and one or more variables associated with the forecasted weather can be used in determining whether such a change is weather may have an effect on demand, and may further forecast a change in demand.

In general, the elements of FIG. 6 perform sales, manufacturing, or consumption of inventory. Retail locations/stores 601-604 for direct consumer sales exhibit the most volatile inventory patterns, due to the random nature and external factors affecting sales. However, manufacturing facilities and sites that consume inventory (such as product integrators, internet shippers, etc. products used in the local facility) also benefit from demand forecasting as disclosed herein. As disclosed, each retail location 601-604 sends sales data and historic forecast data to forecasting system 670. The sales data includes inventory depletion statistics for each item, or SKU/UPC for each sales period, typically days, in the previous sales cycles (i.e. weeks), typically 4-7 weeks of inventory cycles.

Forecasting system 670 stores the sales data in a repository 672, and employs the sales data for generating orders to replenish inventory. The orders include a set of items and a quantity for each item for maintaining the inventory level at a store 601-604.

Many retail ordering schemes rely on days of the week for sales periods and sales cycles. In one configuration, in an inventory management environment having inventory statistics, in which the inventory statistics are specific to each day of the week, inventory system 620 determines target inventory levels by gathering, for each day of the week, inventory level statistics from previous sales. Embodiments compute, based on the inventory level statistics, an inventory level for each day of the week, such that the safety stock accommodates variations in inventory between the different days of the week. Embodiments render, for each of a plurality of items, a stocking level indicative of the target inventory level including the safety stock for each day of the week. Embodiments compute an ordering quantity based on a lead time such that the ordered quantity arrives to satisfy the rendered stocking level on the determined day of the week. Identifying the actual stock levels includes identifying stock levels on the day of the week from previous weeks from the history data, thus focusing on the same day of the week over time, rather than an average of all days in the week.

In particular configurations, the disclosed embodiments may be employed in conjunction with specialized and/or particularly high volume retail sales environments. In large logistics and distribution operations, it is beneficial to load trucks as full as possible, and in the event deferral of items to a successive trip is needed, to select those items which will have a least likely chance of interrupting sales activity. Accordingly, embodiments are operable in conjunction with POS system 99 to identify high velocity or high turnover items that tend to be sold and replenished faster than other items. A UPC bar code symbol or radio-frequency identification (“RFID”) on an item includes a field, designation or value, that alone or in conjunction with a database lookup, designates an item as a high velocity item appropriate for safety stock treatment as defined herein.

A high velocity item may be accommodated by identifying, for each of a plurality of items represented in an inventory database, a field for a product identifier and a field denoting a safety stock for the item, and determining, for each of the product identifiers, a product segmentation field based on product velocity indicative of increased product replenishment demands resulting from a sales volume. The disclosed embodiments determine based on the velocity field, whether to compute a safety stock, i.e. whether the overhead and burden to resupply according to the safety stock is worthwhile given the product throughput.

In other embodiments, supply logistics may invoke a delivery frequency higher than one truck a day, hence triggering a resupply window with a higher granularity. In such a case, the safety stock may be more specific than an individual day, such as a Monday AM and Monday PM, or to designate multiple delivery or time windows within a particular day of the week, such as 7:00 AM, 11:00 AM and 4:00 PM.

Embodiments, including the generated demand forecast, may be employed in implementing supply logistics and designating deliveries (i.e., trucks) and manifest (i.e., contained items) in accordance with demand and profit margins of the transported items. High velocity items might be deemed to have priority space on a particular delivery, but could further be selected based on a profit margin or markup on the included items, and items with the greatest revenue generation potential selected for inclusion.

In such a product inventory shipping environment that uses the demand forecast disclosed herein and has a plurality of transport vehicles, each vehicle (e.g., truck) is configured for receiving a fixed payload of items for delivery to a sales location for inventory replenishment. Embodiments can provide guidance in loading a delivery vehicle, by, for each item of a plurality of items including a first item and a second item, computing a safety stock and determining, based on the computed safety stock of the first item and the second item, a quantity of each of the first item and the second item to be loaded into the delivery vehicle. Embodiments recompute a truck loading quantity based on the safety stock if insufficient space is available in the delivery vehicle for the determined quantity of the first item and the second item, meaning that certain items would need to be omitted and deferred to a successive delivery.

As disclosed, embodiments estimate the seasonality by combining the output of several methods to generate a seasonality prediction model, which has proven to be very robust and provides much more accurate predictions vetted against real retailers' production data sets. One embodiments implements the four Winters models (“Regular” Additive and Multiplicative Holt-Winters methods, and “Revised” Additive and Multiplicative Oracle Holt-Winters methods) as the methods selected at 304. In this embodiment, demand forecast accuracy improved by 10-15% in experimental results, which is an unexpected and surprising increase in accuracy. Advantages to the novel solution include automatically adjusting the over or under fitting issue since the final seasonality is combined based on the estimation error. Further, embodiments require less user intervention than known solutions because the end user does not have to choose a certain methodology based on a sales pattern, as embodiments automatically take care of sales pattern differences. As a result, the demand forecast is more accurate, which prevents lost sales and unnecessary markdowns.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A method of forecasting demand of a product, the method comprising:
receiving historical sales data for the product;
using a plurality of different seasonality estimation methods, estimating a plurality of different seasonality estimations for future time periods and determining an approximate error amount for each of the different seasonality estimations;
determining a weight for each of the plurality of different seasonality estimation methods based on the corresponding approximate error amount;
generating an aggregate seasonality model based on the plurality of different seasonality estimations and the weights; and
determining a demand forecast using the aggregate seasonality model.

2. The method of claim 1, wherein the historical sales data comprises seasonality indices for each of a plurality of time periods.

3. The method of claim 2, where the aggregate seasonality model comprises an aggregate seasonality value for each of the plurality of time periods.

4. The method of claim 1, further comprising continuously receiving additional new historical sales data and, in response, continuously retraining the aggregate seasonality model.

5. The method of claim 1, wherein the determining the weight comprises:
$${W}_{i} = \frac{1 / R M S E ( i )}{{Σ}_{i = 1}^{n} 1 / RMSE ( i )}$$
wherein the approximate error amount is determined using Root Mean Square Error (RMSE) for each seasonality estimation method i for each of n seasonality estimation methods.

6. The method of claim 5, wherein the generating the aggregate seasonality model comprises:
$${S}_{t} = {\sum }_{i = 1}^{n} {W}_{i} {s}_{i}^{t}$$
wherein Sₜ is the estimated seasonality at period (t), sᵢ^{t} is the estimated seasonality by method (i) at period (t) and Wᵢ is the weight of the method (i).

7. The method of claim 1, wherein the plurality of different seasonality estimation methods comprise regular Additive and Multiplicative Holt-Winters methods, and revised Additive and Multiplicative Oracle Holt-Winters methods.

8. The method of claim 1, further comprising:
based on the demand forecast demand for the product, causing an amount of inventory of the product to be transported to one or more locations.

9. A computer-readable medium having instructions stored thereon that, when executed by a processor, cause the processor to forecast demand of a product, the forecasting comprising:
receiving historical sales data for the product;
using a plurality of different seasonality estimation methods, estimating a plurality of different seasonality estimations for future time periods and determining an approximate error amount for each of the different seasonality estimations;
determining a weight for each of the plurality of different seasonality estimation methods based on the corresponding approximate error amount;
generating an aggregate seasonality model based on the plurality of different seasonality estimations and the weights; and
determining a demand forecast using the aggregate seasonality model.

10. The computer-readable medium of claim 9, wherein the historical sales data comprises seasonality indices for each of a plurality of time periods.

11. The computer-readable medium of claim 10, where the aggregate seasonality model comprises an aggregate seasonality value for each of the plurality of time periods.

12. The computer-readable medium of claim 9, the forecasting further comprising continuously receiving additional new historical sales data and, in response, continuously retraining the aggregate seasonality model.

13. The computer-readable medium of claim 9, wherein the determining the weight comprises:
$${W}_{i} = \frac{1 / R M S E ( i )}{{Σ}_{i = 1}^{n} 1 / RM S E ( i )}$$
wherein the approximate error amount is determined using Root Mean Square Error (RMSE) for each seasonality estimation method i for each of n seasonality estimation methods.

14. The computer-readable medium of claim 13, wherein the generating the aggregate seasonality model comprises:
$${S}_{t} = {\sum }_{i = 1}^{n} {W}_{i} {s}_{i}^{t}$$
wherein Sₜ is the estimated seasonality at period (t), sᵢ^{t} is the estimated seasonality by method (i) at period (t) and Wᵢ is the weight of the method (i).

15. The computer-readable medium of claim 9, wherein the plurality of different seasonality estimation methods comprise regular Additive and Multiplicative Holt-Winters methods, and revised Additive and Multiplicative Oracle Holt-Winters methods.

16. The computer-readable medium of claim 9, the forecasting further comprising:
based on the demand forecast demand for the product, causing an amount of inventory of the product to be transported to one or more locations.

17. A product demand forecasting system for predicting future demand for a product, the system comprising:
one or more processors coupled to one or more point of sale systems, the processors receiving historical sales data for the product;
the processors further adapted to:
determine a weight for each of the plurality of different seasonality estimation methods based on the corresponding approximate error amount;
generate an aggregate seasonality model based on the plurality of different seasonality estimations and the weights; and
determine a demand forecast using the aggregate seasonality model.

18. The system of claim 17, wherein the historical sales data comprises seasonality indices for each of a plurality of time periods.

19. The system of claim 18, where the aggregate seasonality model comprises an aggregate seasonality value for each of the plurality of time periods.

20. The system of claim 17, further comprising continuously receiving additional new historical sales data and, in response, continuously retraining the aggregate seasonality model.
